(19) United States
(12) Patent Application Publication
(10) Pub. No.: US 2010/0132177 A1
(43) Pub. Date: Jun. 3, 2010

(54) METHOD AND BLASTING AGENT FOR SURFACE PEENING

(75) Inventor: Philipp Thümmler, Munich (DE)

Correspondence Address: HOWISON & ARNOTT, L.L.P, P.O. BOX 741715, DALLAS, TX, 75374-1715, US

(73) Assignee: MTU AERO ENGINES, GMBH, Munich (DE)

(21) Appl. No.: 12/529,007

(22) PCT Filed: Feb. 20, 2008
(86) PCT No.: PCT/DE08/00302

§ 371 Date: Jan. 26, 2010

(30) Foreign Application Priority Data
Feb. 27, 2007 (DE) 10 2007 009 471.1

(51) Int. Cl. B24C 1/10; B24C 11/00; C09K 3/14

(52) U.S. Cl. 29/90.7; 451/38; 451/89; 428/402

(57) ABSTRACT

The present invention relates to a method for the surface peening, in particular for the ultrasonic shot peening, of component (10), in particular of a gas turbine, wherein at least one partial region (12) of the surface of the component (10) is strengthened by applying a blasting agent comprising a plurality of individual blasting particles (56, 58), wherein a blasting agent is used the blasting particles (56, 58) of which have at least two different particle sizes and/or are made of at least two different materials. The invention further relates to such a blasting agent for surface peening.

### CROSS-REFERENCE TO RELATED APPLICATIONS

This application is a U.S. National Phase application submitted under 35 U.S.C. §371 of Patent Cooperation Treaty application serial no. PCT/DE2008/000302, filed Feb. 20, 2008, and entitled METHOD AND BLASTING AGENT FOR SURFACE PEENING, which application claims priority to German patent application serial no. DE 10 2007 009 471.1, filed Feb. 27, 2007, and entitled VERFAHREN UND STRAHLMITTEL ZUM OBERFLÄCHENSTRAHLEN, the specifications of which are incorporated herein by reference in their entireties.

### TECHNICAL FIELD

The invention relates to a method for surface blasting, in particular ultrasonic shot blasting, of a component, in particular a gas turbine. In addition, the invention relates to a blasting agent for surface blasting, in particular for ultrasonic shot blasting of such a component.

### BACKGROUND

To improve the wear properties of such components, e.g., the rotor of a gas turbine, a variety of different methods of surface blasting and a blasting agent used for this purpose are currently being used in particular, depending on which surface area is to be treated. Ultrasonic blasting methods are commonly used today to improve the wear properties of the rotating blades of a rotor or of central and planar areas of disks. Such a method can be derived from EP 1 101 568 B1, for example, where the rotor blades of a rotor designed as a blisk in particular to improve their fatigue resistance, are shot-blasted. To do so, the rotor is positioned in a holding device so that it is mounted to rotate about an axis of rotation. By rotation of the rotor, the desired partial areas of the surface of the blisk are passed through a blasting chamber, which has a vibrating device in the form of an ultrasonic sonotrode with a vibrating surface running horizontally and acting upon the blasting agent. The blasting chamber is bordered by appropriate chamber walls both axially and radially in relation to the blisk. For treating at least the partial area of the surface of the component, the blasting agent comprising a plurality of individual blasting particles in the form of blasting shot is used.

With complex components in particular, however, there is the problem with the previous methods of surface blasting that although planar, i.e., flat, partial areas of the surface of the component can be hardened in a highly homogeneous manner, the partial areas which are designed as or have internal radii, corners or the like, cannot be homogeneously hardened.

### SUMMARY

The object of the present invention is therefore to create a method and a blasting agent of the type defined in the preamble with which complex components and in particular internal radii, corners or the like can be hardened in an improved and more homogeneous manner.

This object is achieved according to the invention by a method having features in accordance with one aspect and by a blasting agent having features in accordance with another aspect. Advantageous embodiments with expedient and nontrivial refinements of the invention are defined in the dependent patent claims.

To create a method for surface blasting with which even complex components, e.g. those with internal radii, can be surface blasted and/or hardened in an extremely homogeneous manner, it is provided according to the present invention that a blasting agent will be used such that the blasting particles in this blasting agent have at least two different particle sizes and/or consist of at least two different materials. In other words, it is provided according to the present invention that surface blasting is to be performed using a blasting agent in which the blasting particles do not have just one essentially uniform size and/or consist of a uniform material but instead have at least two different particle sizes and/or are created from at least two different materials. For example, if blasting particles of at least two different particle sizes are used, this can achieve the result that the planar, i.e., flat partial areas of the surface of the component are blasted and hardened extremely homogenously and uniformly by means of the larger blasting particles while the blasting particles with a smaller particle size serve in particular to ensure that even internal radii or corners with a small diameter accordingly are sufficiently well hardened, for example. By using a targeted blasting agent mixture with two blasting agent sizes and/or particle sizes that preferably differ significantly from one another, this achieves the result that, firstly, with the large blasting particles, the desired intensity and hardening are achieved while, secondly, with the small blasting particles the internal radii and/or corners of the complex components are completely blasted and/or hardened in one blasting operation. The small blasting particles thus serve in particular so that even the internal radii or corners which are not reached by the larger blasting particles because of their particle size can still be blasted. It is apparent that through the use of blasting particles with at least two different particle sizes, the partial areas of the surface of the component which are smaller than the particle size of the large blasting particles can also be blasted by means of the small blasting particles. Through the targeted mixture of the large and small blasting particles, thus the desired intensity and hardening are achieved on the one hand, while on the other hand, complete coverage of the complete partial area of the surface to be hardened is achieved.

If blasting particles of at least two different materials are used, then in addition, the blasting effect of the blasting agent can be further optimized. For example, it is conceivable for the kinetic energy of the smaller blasting particles to be increased by a corresponding material with a higher density in comparison with the larger blasting particles, so that a homogeneous intensity distribution can be ensured, e.g., even in the internal radii or corners of the component. In other words, through the use of a suitable mixture of larger blasting particles with a relatively lower density and smaller blasting particles with a relatively higher density, a homogeneous intensity distribution of the surface blasting and thus a uniform hardening can be achieved over the planar and/or flat partial areas as well as over the internal radii and/or corners of the component.

It has been found to be advantageous to use blasting shot of at least two different diameters and/or blasting agents and/or of at least two different materials as the blasting agent. Through a suitable choice of the diameter, a highly reproducible blasting result and/or a uniform hardening of the surface of the component can be ensured.

It has also proven advantageous if the particle size and/or diameter of the at least one part—preferably the smaller blasting particles and/or blasting shot—of the blasting agent is/are adapted to the respective radii, corners or the like of the component. By adjusting the blasting particles and/or blasting shot, it is thus possible to achieve the result that even the radii, corners or the like are completely covered and hardened.

In a further embodiment of the invention it has proven to be especially advantageous if smaller blasting particles and/or blasting shot, whose particle sizes and/or diameters are in a range between 0.3 mm and 1.3 mm and preferably in a range of approximately 0.8 mm are used.

Through such a particle size and/or such a diameter, especially homogeneous hardening of the flat partial areas of the component can be achieved.

However, the larger blasting particles and/or blasting shot is/are used, preferably with a particle size and/or diameter in a range between 1.0 mm and 4.0 mm, and preferably in a range of approximately 1.5 mm. An especially homogeneous hardening of the flat partial areas of the component can be achieved with such a particle size and/or such a diameter.

Finally, it has proven advantageous to use smaller blasting particles and/or blasting shot having a greater density than that of the larger blasting particles and/or blasting shot. In other words, it has proven especially advantageous if the kinetic energy of the smaller blasting particles and/or blasting shot is adapted to that of the larger blasting particles and/or blasting shot—for example, through a suitable choice of materials—so that on the whole, a homogeneous intensity distribution of the blasting agent over the entire surface of the component to be blasted can be achieved, i.e., including the internal radii, corners or the like.

The advantages described above in conjunction with the inventive method are likewise applicable for the inventive blasting agent for surface blasting, characterized in particular in that the blasting particles comprise at least two different particle sizes and/or are made of at least two different materials.

It is also to be considered as within the scope of the present invention that the inventive method and blasting agent may of course be used not only in ultrasonic blasting but, if necessary, also in other methods which fall under conventional shot blasting methods, e.g., compressed air blasting or centrifugal blasting. In addition, it should be recalled that the different particle sizes of the smaller and larger blasting particles may lie in a particular size range. In other words, “particle size” is to be understood as meaning not just a single particle size and/or shot size but instead a corresponding size range.

### BRIEF DESCRIPTION OF THE DRAWINGS

Additional advantages, features and details of the invention are derived from the following description of a preferred exemplary embodiment and on the basis of the drawing.

FIG. 1 is a schematic section view through a component of a gas turbine with external gearing which is to be processed in the area of a blasting chamber by surface blasting.

### DETAILED DESCRIPTION

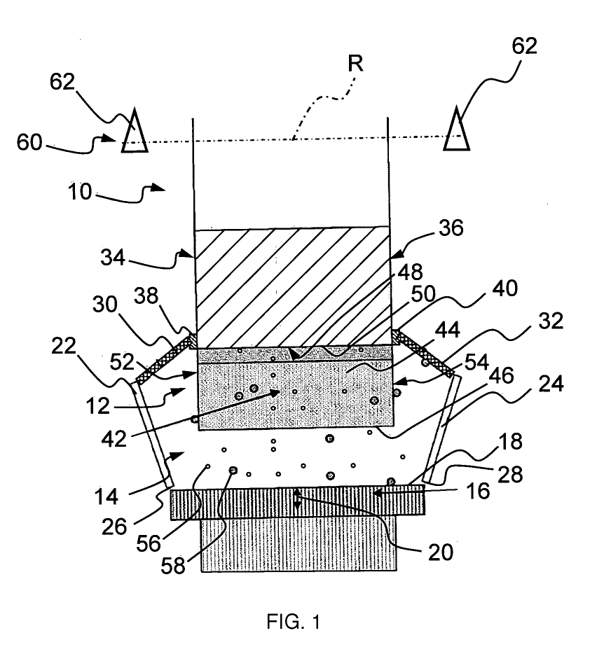

Referring now to FIG. 1, there is illustrated a schematic sectional view through a component of a gas turbine with external gearing which is to be processed in the area of a blasting chamber by surface blasting. Within this blasting chamber, blasting agents whose particle sizes comprise at least two different particle sizes are accelerated.

FIG. 1 shows a schematic sectional view of a component 10 of a gas turbine in the form of an essentially disk-shaped gear wheel designed with rotational symmetry about its axis of rotation R. On the outer circumference, the component 10 comprises external gearing 12, which is positioned within a blasting chamber 14 for surface blasting of the component 10. Of the blasting chamber 14, which is also shown in a schematic sectional view in the figure, essentially a vibrating device 16 designed as an ultrasonic sonotrode in the present case, for example, can be seen. On its side facing the external gearing 12 of the component 10, the vibrating device 16 comprises a surface 18 acted upon by the blasting agent and excited by the ultrasonic sonotrode. The arrow 20 here indicates schematically the direction of movement of the vibrating surface 18

The two blasting chamber walls 22, 24 of the vibrating device 16 are connected to the surface 18 with a gap 26, 28 being provided between the vibrating and/or oscillating surface 18 and the blasting chamber walls 22, 24 so that the surface 18 can oscillate freely. The blasting chamber walls 22, 24 in the present case are inclined outward with respect to the surface 18 at an angle of approximately 100° to 120°. The respective reflective walls 30, 32 which are held by the respective blasting chamber wall 22, 24 in a manner not specified in the present case are connected to the blasting chamber walls 22, 24. The reflective walls 30, 32 may be arranged adjustably with respect to the blasting chamber walls 22, 24 by means of corresponding hinges. The two reflective walls 30, 32 are also arranged at an angle of approximately 100° to 120° with respect to the particular blasting chamber wall 22, 24. In order to avoid a loss of blasting agent from the blasting chamber 14, seals 38, 40 are provided between the reflective walls 30, 32 and the respective end faces 34, 36 of the disk-shaped component 10.

On the front and back sides of the blasting chamber 14, blasting chamber walls and/or reflective walls running across the blasting chamber walls 22, 24 in a manner not shown in greater detail here are arranged so that the blasting chamber 14 is closed at least approximately completely against loss of blasting agent. It is clear that the blasting chamber walls and/or reflective walls arranged on the front and back sides may be designed to be flexible and/or movable accordingly so that rotation of the component 10 with the external gearing 12 about the axis of rotation R is possible.

Of the respective tooth 42 of the external gearing 12, the figure shows one of the two tooth flanks 44, which extends between a respective tooth upper side 46 and a respective tooth gap base 48. For example, an internal radius 50, which is also to be hardened by surface blasting, in addition to hardening the tooth flank 44 and/or the tooth gap base 48 in a manner to be explained in greater detail below, runs between the tooth flank 44 and the tooth gap base 48. Two end faces 52, 54 of the respective tooth 42 also run perpendicular to the tooth surface 46 and/or to the tooth flank 44 in the present case.

To achieve the result that both the flank 44 and the tooth gap base 48 as well as the internal radius 50 can be hardened equally well and homogeneously by the external gearing 12 and/or the respective tooth 42, in the present case of surface blasting, a blasting agent in the form of blasting particles and/or blasting shot 56, 58 having at least two different particle sizes are used. In other words, smaller blasting shot 56 and larger blasting shot 58 which have different particle sizes and/or different diameters are arranged in the blasting chamber 14. The particle size and/or diameter of the larger blasting shot 58 in the present case is/are in a range from approximately 1.0 mm to 4.0 mm, for example, in particular in the range from approximately 1.2 mm to 1.8 mm. In a special embodiment, the particle size and/or diameter of the larger blasting shot 58 is in the range of approximately 1.5 mm. If the larger blasting shot 58, which is manufactured primarily from a steel alloy, is used in the stated ranges, this yields an especially advantageous and homogeneous hardening of the planes and/or flat partial areas of the surface of the component in particular, such as those represented by the respective tooth flanks 44, the respective tooth upper sides 46 or the respective tooth gap base 48, for example.

The small blasting particles and/or blasting shot 56, which can also be manufactured from a steel alloy in the present case, has/have a particle size and/or a diameter in a range between 0.3 mm and 1.3 mm, whereby smaller blasting shot 56 in a range between 0.5 mm and 1.0 mm in particular is used. In a specific embodiment, the particle size and/or diameter of the smaller blasting shot 56 is in the range of approximately 0.8 mm. Through the stated ranges of the smaller blasting shot 56 in particular it is possible to achieve the result that the corresponding small internal radii 50 can be hardened. In other words, the smaller blasting shot 56 is adapted in particle size and/or diameter to the respective internal radii 50 accordingly, so that these smaller radii can be hardened accordingly by the small blasting shot 56. It is clear that the particle size and/or the diameter of the smaller blasting particles and/or blasting shot 56 must therefore be designed to be smaller accordingly or the same as the corresponding internal radius 50.

In order to achieve a homogeneous hardening over the planar partial areas of the surface of the component 10—for example, the respective tooth flank 44, the respective tooth upper side 46 or the respective tooth gap base 48—as well as the respective internal radius 50 and/or a respective corner of the component 10, the larger blasting shot and/or the smaller blasting shot 56, 58 is/are preferably made of different materials and/or they have different densities. The smaller blasting shot 56 in particular may have a higher density in relation to the larger blasting shot 58, so that after a corresponding acceleration by means of the vibrating device 16, the smaller shot has a higher kinetic energy than the larger blasting shot 58. This achieves the result that both the planar, i.e., flat partial areas of the surface of the component 10, as well as the respective internal radii 50, for example, are hardened uniformly, i.e., homogeneously. In other words, a homogeneous intensity distribution over the entire surface of the component 10 is achieved by means of said blasting agent.

On the whole, it is thus apparent that with the targeted mixture of blasting particles and/or blasting shot 56, 58 having at least two definitely different particle sizes and/or diameters, a uniform hardening of the planar partial areas as well as the internal radii 50, corners or the like can be achieved, with the desired intensity and hardening of the planar partial areas being achieved with the large blasting particles and/or blasting shot 58 in particular, while the internal radii 50 can be hardened completely in one and the same blasting operation by using the smaller blasting particles and/or blasting shot 56 in particular. Coverage and/or hardening of the component 10 is/are also achieved by the smaller blasting shot 56 in the area of the respective internal radii 50. Another advantage of the mixture of the blasting particles and/or blasting shot 56, 58 is that the deformation of component edges due to the blasting operation can be reduced by using a mixture with small blasting shot 56.

Finally, the figure shows that in the present case, the present disk-shaped component 10 can be rotated about its axis of rotation R by means of a holding mechanism 60, so that all the teeth 42 of the external gearing 12 can be passed through the blasting chamber 14. Essentially two bearing blocks 63 of the holding mechanism 60 can be seen here.

1-14. (canceled)

15. A method for surface blasting of a component, comprising the steps:
providing a component having a surface to be hardened;
accelerating a blasting agent toward the surface to be hardened using a vibrating device;
the blasting agent comprising a plurality of individual blasting particles;
the plurality of blasting particles being dividable into at least two groups on the basis of one of different particle size and different particle material; and
whereby at least a partial area of the surface of the component is hardened by the action of the blasting agent.

16. A method according to claim 15, wherein the blasting particles are blasting shot having one of:
at least two different diameters; and
at least two different materials.

17. A method according to claim 15, wherein:
the surface of the component to be hardened includes at least one of radii and corners; and
the particle size of the blasting particles in at least one group of the blasting particles are adapted to the at least one of radii and corners.

18. A method according to claim 15, wherein the blasting particles in the at least two groups have different densities.

19. A method according to claim 15, wherein:
the plurality of blasting particles are dividable into at least two groups on the basis of different particle size including a larger size group and a smaller size group; and
the blasting particles in the smaller size group have particle sizes in a range between 0.3 mm and 1.3 mm.

20. A method according to claim 19, wherein the blasting particles in the larger size group have particle sizes in a range between 1.0 mm and 4.0 mm

21. A method according to claim 15, wherein:
the plurality of blasting particles are dividable into at least two groups on the basis of different particle size including a larger size group and a smaller size group;
the blasting particles in the larger size group and the smaller size group have different densities; and
the blasting particles in the smaller size group have a density that is greater than that of the blasting particles in the larger size group.

22. A blasting agent for surface blasting, the blasting agent comprising a plurality of individual blasting particles, the plurality of blasting particles being dividable into at least two groups on the basis of one of different particle size and different particle material.

23. A blasting agent according to claim 22, wherein the blasting particles are blasting shot having one of:
at least two different diameters; and
at least two different materials.

24. A blasting agent according to claim 22, wherein the particle size of the blasting particles in at least one group of the blasting particles is adapted to at least one of radii and corners present on a surface of a component to be hardened.

25. A blasting agent according to claim 22, wherein the blasting particles in the at least two groups have different densities.

26. A blasting agent according to claim 22, wherein:
the plurality of blasting particles are dividable into at least two groups on the basis of different particle size including a larger size group and a smaller size group; and
the blasting particles in the smaller size group have particle sizes in a range between 0.3 mm and 1.3 mm.

27. A blasting agent according to claim 26, wherein the blasting particles in the larger size group have particle sizes in a range between 1.0 mm and 4.0 mm

28. A blasting agent according to claim 22, wherein:
the plurality of blasting particles are dividable into at least two groups on the basis of different particle size including a larger size group and a smaller size group;
the blasting particles in the larger size group and the smaller size group have different densities; and
the blasting particles in the smaller size group have a density that is greater than that of the blasting particles in the larger size group.

29. A method for surface blasting of a component, comprising the steps:
providing a component having a surface to be hardened;
providing a blasting agent comprising a plurality of individual blasting particles, the plurality of blasting particles being dividable into at least a larger size group and a smaller size group on the basis of different particle size; and
accelerating the blasting agent toward the surface to be hardened using a vibrating device such that the blasting particles of the smaller size group have a higher kinetic energy than the blasting particles of the larger size group;
whereby at least a partial area of the surface of the component is hardened by the action of the blasting agent.

30. A method according to claim 29, wherein the blasting particles in the smaller size group have a density that is greater than that of the blasting particles in the larger size group.

31. A method according to claim 29, wherein the vibrating device includes a ultrasonic sonode.

32. A method according to claim 29, further comprising the step of confining the blasting agent within a blasting chamber defined by walls extending between the vibrating device and the surface to be hardened.

33. A method according to claim 32, wherein the walls defining the blasting chamber are separated from the vibrating device by a gap.

34. A method according to claim 32, wherein:
the vibrating device includes a flat surface; and
at least some of the walls defining the blasting chamber are inclined outward at an angle within the range from approximately 100 degrees to approximately 120 degrees with respect to the flat surface of the vibrating device.
